(19) United States
(12) Patent Application Publication
(10) Pub. No.: US 2005/0028465 A1
(43) Pub. Date: Feb. 10, 2005

(54) Door, method of making the door and panel component formed therefrom

(76) Inventors: Andrew J. Horsfall, Middleton Leeds (GB); David Paxton, Warmsworth (GB); Steven K. Lynch, St. Charles, IL (US)

Correspondence Address: Joseph W. Berenato, III;Liniak, Berenato & White, LLC, Suite 240, 6550 Rock Spring Drive, Bethesda, MD, 20817, US

(21) Appl. No.: 10/851,659

(22) Filed: May 24, 2004

Related U.S. Application Data
(60) Provisional application No. 60/472,741, filed on May 23, 2003.

(51) Int. Cl. E06B 1/04

(52) U.S. Cl. 52/455

(57) ABSTRACT

The present invention is related to a door and a door skin. The door includes a peripheral doorframe and a window frame having opposed first and second sides. First and second door facings are secured to opposing sides of the peripheral doorframe. Each of the door facings has an opening. The door facings have adjacently disposed inner surfaces, and each of the opposing sides of the window frame is secured to an associated inner surface about the associated opening. A window is secured within the window frame. The present invention is also related to a method of making the door, and a panel component resulting from the disclosed door making process.

### CROSS REFERENCE TO RELATED APPLICATIONS AND CLAIM TO PRIORITY

This is a non-provisional application of provisional patent application No. 60/472,741, filed May 23, 2003, the disclosure of which is incorporated by reference and priority to which is claimed under 35 U.S.C. § 120.

### FIELD OF THE INVENTION

The present invention is related to a door, preferably a glazed door. The glazed door includes a peripheral doorframe and a window frame having opposed first and second sides. First and second door facings are secured to opposing sides of the peripheral doorframe. Each of the door facings has an opening. The door facings have adjacently disposed inner surfaces, and each of the opposing sides of the window frame is secured to an associated inner surface about the associated opening. A window is secured within the window frame. The present invention is also related to a method of making the glazed door, and a panel component resulting from the disclosed method.

### BACKGROUND OF THE INVENTION

Man-made boards, such as fiberboard, e.g., hardboard; chipboard; oriented strand board-fiberboard composites; particle board; oriented strand board-particle board composites; and the like, commonly are embossed on their intended visible major surface in the manufacture of interior paneling, wainscoting, exterior siding, and particularly in the manufacture of door facings. As well known in the art, door facings may be laminated to a support structure or frame to form a hollow core door. The facings may be formed to simulate multi-panel doors.

Such articles may be molded from a planar cellulosic mat, which typically includes cellulosic fibers or particles and a resin binder. The mat may be molded to include one or more depressions or grooves, such as one or more square or rectangular depressions that do not extend to an outer edge of the article. These depressions may define the perimeter of one or more simulated panels.

Molded articles are generally much less expensive than comparative solid, natural wood articles. In addition, various methods of producing molded articles having a relatively high quality exterior surface have been developed. For example, a molded article having a high quality exterior surface with decorative molded depressions is disclosed in U.S. Pat. No. 5,543,234 to Lynch et al., the disclosure of which is incorporated herein by reference. Molded articles may also be formed to have outwardly extending contoured portions by “reverse molding” techniques, as disclosed in WO 0181055 to Lynch et al., the disclosure of which is incorporated herein by reference.

It is sometimes desirable for doors to have a glazing unit, frequently provided in the form of a cassette. A cassette is a framed window assembly adapted to be mounted to a door. The cassette and door blank are generally manufactured separately from one another. As well known in the art, a hollow core door may include a peripheral frame and two door facings, wherein each facing is secured to an opposite side of the frame. In addition to the peripheral frame, a smaller, internal window frame may also be provided for accommodating a cassette. A portion of each door facing is routed or cut out in an area corresponding to the area defined by the window frame. The facings are then secured to the frames using an adhesive. Then, the cassette is mounted within the window frame, and secured therein using screws, molding, or some other suitable fastening means.

Cassettes are available in a variety of shapes and sizes, and comprise first and second halves that hold a separate glass unit. Cassettes are installed on a door after the door facings and internal framing have been pressed together and removed from the press. The first halve of the cassette is positioned against one facing. The glass is then placed in position, and the second halve is positioned against the opposing facing, sandwiching the glass therebetween. The cassette is then secured in place on the door using pins or screws. Thus, the cassette must be mounted to the door after the door has been pressed, thereby increasing manufacturing time and cost. Therefore, conventional glazed doors having such cassettes are relatively expensive, given the additional manufacturing steps and materials required. In addition, some cassettes are formed from relatively expensive plastic, which further increases the cost of manufacture.

Cassettes typically have a thickness that is greater than the thickness of the doorframe, and protrude outwardly from the exteriorly disposed surfaces of the door facings. The resulting glazed door includes a window assembly that protrudes outwardly from the exterior plane of the door facings, which may be undesirable to consumers. Furthermore, the cassette on such a glazed door may be easily damaged, particular during transit, given it protrudes from the exterior plane of the door facings.

Conventional methods of making such glazed doors are not cost efficient, since the part cut out from the door facing has no further use and is generally discarded as scrap. Typically, portions of the facings that will accommodate the cassette are removed by cutting or routing. This often results in an unfinished, sharp edge on both the door facing and the portions being scrapped. The resulting door may appear unfinished and unacceptable to consumers.

Therefore, there is a need for a glazed door, and a method of making the glazed door, that is cost efficient, whereby cut out portions of the facings are not discarded as scrap. The glazed door should be aesthetically pleasing to consumers, having a window assembly profile that does not protrude from the exterior plane of the door facings.

### SUMMARY OF THE INVENTION

A door comprises a peripheral doorframe and a window frame having opposed first and second sides. First and second door facings are secured to opposing sides of the peripheral doorframe. Each of the door facings has an opening. The door facings have adjacently disposed inner surfaces and each of the window frame sides is secured to an associated inner surface about the associated opening. A window is secured within the window frame.

A molded door skin that is pressed so that one or more interior panels are severed from the frame or the door skin has a perforated interior panel or weak fracture area surrounding an interior panel that can easily be sanded or punched out in a post forming procedure.

The present invention is also directed to a method of making a door. First and second door facings are provided. Each of the door facings has adjacently disposed inner surfaces and a panel portion. The panel portion is removed from each of the facings to form an opening. A peripheral doorframe and a window frame having opposing first and second sides are provided. A window is secured within the window frame. The door facings are secured to opposing sides of the peripheral doorframe, and an associated inner surface about the associated opening of each of the door facings is secured to each of the window frame sides. The removed panel portion may be secured to a surface.

### DESCRIPTION OF THE FIGURES

FIG. 1 is an elevational view of a glazed door according to the present invention;

FIG. 2 is a fragmentary cross-sectional view of a first embodiment taken along line 2-2 of FIG. 1 and viewed in the direction of the arrows;

FIG. 3 is a cross-sectional view of a glazing bead for use with the invention of FIG. 1;

FIG. 4 is a fragmentary cross-sectional view of a door according to a second embodiment;

FIG. 5 is a cross-sectional view of a notched glazing bead according to the second embodiment;

FIG. 6 is a fragmentary cross-sectional view of a door according to a third embodiment;

FIG. 7 is a fragmentary cross-sectional view of a door according to a fourth embodiment;

FIG. 8 is a fragmentary cross-sectional view of a door according to a fifth embodiment;

FIG. 9 is a cross-sectional view of the window frame according to the fifth embodiment;

FIG. 10 is an elevational view of a glazed door having two windows according to the present invention;

FIG. 11 is an elevational view of a glazed door having two windows and two panels according the present invention;

FIG. 12 is a fragmentary cross-sectional view of a contoured portion of a door facing;

FIG. 13 is a fragmentary cross-sectional view of the contoured portion of the door facing of FIG. 12 after removing a base of the contoured portion;

FIG. 14 is an elevational view of a plant-on panel component according to the present invention;

FIG. 15 is a cross sectional view taken along line 15-15 of FIG. 14 and viewed in the direction of the arrows;

FIG. 16 is a cross-sectional view of a panel component having angled edges;

FIG. 17 is a cross-sectional view of a panel component having curved edges;

FIG. 18 is a cross-sectional view of a panel component without a skirt portion;

FIG. 19 is a cross-sectional view of a door having the panel component of FIG. 18 secured thereon;

FIG. 20 is a cross-sectional view of a door having the panel component of FIG. 17 secured thereon;

FIG. 21 is a cross-sectional view of a mold die set and resulting door skin according to yet another embodiment.

### DETAILED DESCRIPTION OF THE INVENTION

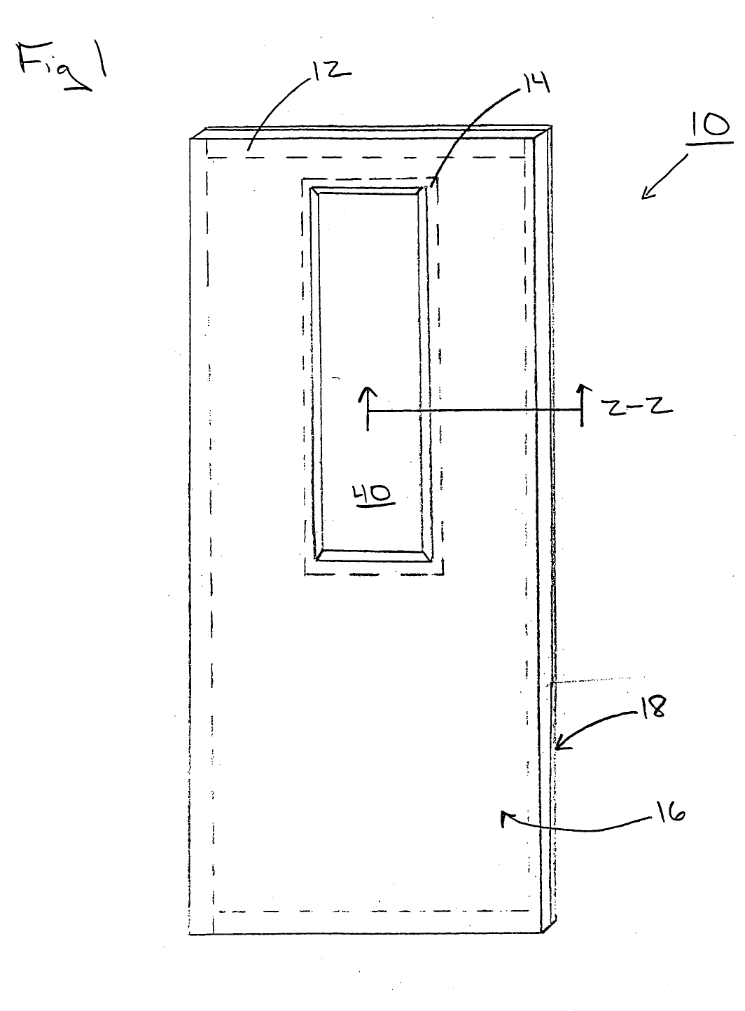

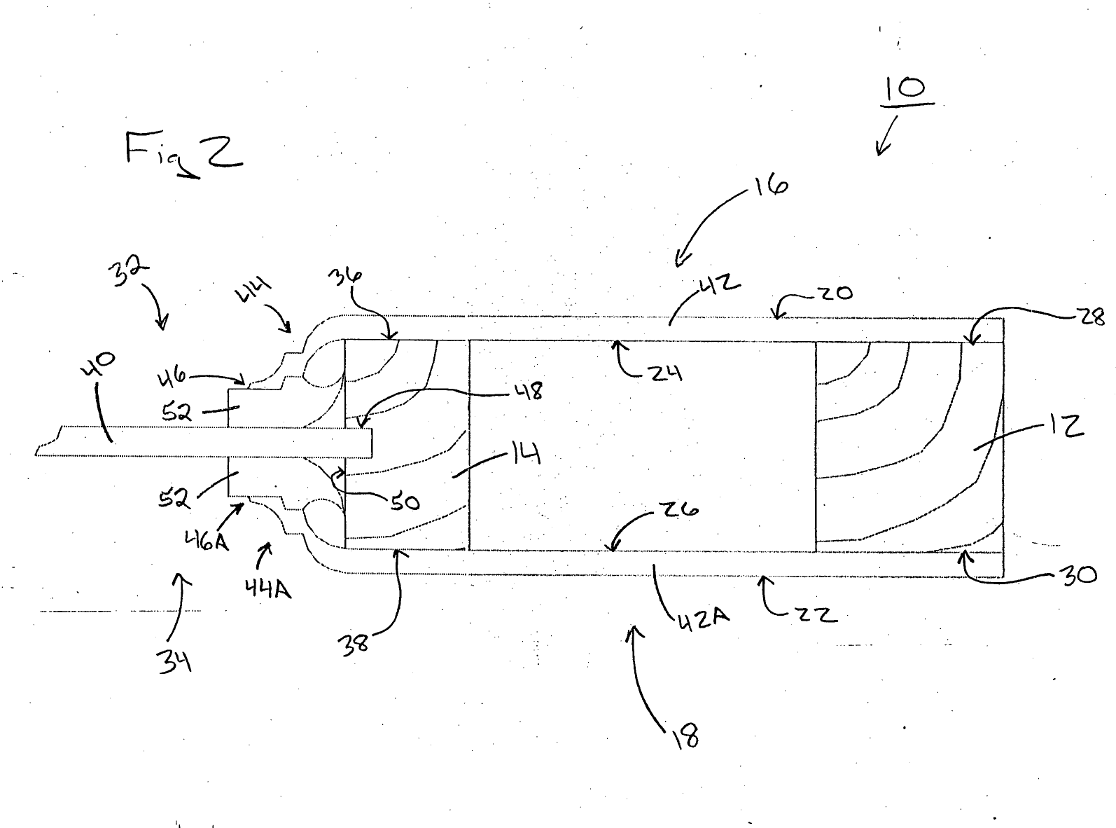

As best shown in FIGS. 1 and 2, a door 10 includes a peripheral doorframe 12, a window frame 14, and first and second door facings 16, 18. Each facing 16, 18 has an exterior surface 20, 22 and an interior surface 24, 26, respectively, secured to opposing first and second sides 28, 30 of peripheral doorframe 12, as best shown in FIG. 2. Each facing 16, 18 has an opening 32, 34. Interior surfaces 24, 26 are also secured to opposing first and second sides 36, 38 of window frame 14 about openings 32, 34. A window 40 is secured within window frame 14. While the door 10 in the preferred embodiment is an entry door, those skilled in the art recognize that the door could be a cabinet door, furniture door, or the like.

As best shown in FIG. 2, door facing 16 preferably includes a major planar surface 42 lying on a first plane and a contoured portion 44 extending inwardly from the plane of major planar surface 42 relative to exterior surface 20. An edge 46 of contoured portion 44 defines opening 32 on door facing 16. Likewise, door facing 18 preferably includes a major planar surface 42A lying on a first plane and a contoured portion 44A extending inwardly from the plane of major planar surface 42A relative to exterior surface 22. An edge 46A of contoured portion 44A defines opening 34 on facing 18. Interior surface 24 of door facing 16 is secured to first side 36 of window frame 14 and interior surface 26 of door facing 18 is secured to second side 38 of window frame 14, so that openings 32, 34 are aligned.

Preferably, window frame 14 has a thickness that is substantially equal to the thickness of peripheral doorframe 12. Door facings 16, 18 typically have a thickness of about 3.0 mm. Conventional doors generally have a total thickness of 34.0 mm, 40 mm, or 44 mm. Preferably, window frame 14 and peripheral doorframe 12 each have a thickness of about 28.0 mm, 34.0 mm, or 38.0 mm, depending on the total thickness desired (and the thickness of door facings 16, 18). In this way, one press may be used for door facings 16, 18, and one thickness of glass for window 40 may be used for manufacturing doors of variable thickness. A different door thickness is achieved simply by changing the thickness of window frame 14 and peripheral doorframe 12. This provides a relatively inexpensive method of manufacturing doors having different thicknesses, since the material used to form window frame 14 and peripheral doorframe 12 is relatively inexpensive.

By contrast, conventional methods of manufacturing different thickness doors typically require changing the profile depth of the contoured portion of the door facing. This involves using a different press for different door facings. Alternatively, conventional methods may require that thicker window glass be used to make a thicker door. Such conventional methods are substantially more expensive, given additional equipment (i.e. multiple presses) and/or relatively expensive materials (i.e. relatively thick glass) are required.

As best shown in FIG. 2, window frame 14 preferably includes a groove 48 for receiving window 40. Groove 48 is provided in an inwardly facing surface 50 of window frame 14 relative to openings 32, 34. Groove 48 is preferably formed in surface 50 so that window 40 is equidistant from exterior surfaces 20, 22. Groove 48 has a width corresponding to the thickness of window 40.

Glazed door 10 preferably also includes some type of spacer between contoured portions 44, 44A and the opposing sides of window 40. As best shown in FIG. 2, glazing bead 52 is disposed between contoured portion 44 and window 40, and between contoured portion 44A and the opposite side of window 40. Glazing bead 52 may be inserted into position after glazed door 10 is pressed.

As best shown in FIGS. 2 and 3, glazing bead 52 includes a ridge 54 and a curved tip 56. Glazing bead 52 preferably is formed from a resilient material, such as rubber, PVC, or a similar resilient material. Preferably, the resilient material has sufficient compressibility to allow for deformation during installation. During installation, glazing bead 52 is pushed into place, between edge 46 of contoured portion 44 and edge 46A of contoured portion 44A along opposite sides of window 40. Glazing bead 52 deforms during installation, so that ridge 54 may be pushed past edges 46, 46A. In addition, curved tip 56 is forced against inwardly facing surface 50, and bends outwardly from window 40. After insertion, ridge 54 re-forms to its initial configuration (as shown in FIG. 2), and prevents glazing bead 52 from pushing out past edges 46, 46A. In addition, curved tip 56 is tensioned against inwardly facing surface 50 and window 40. In this way, window 40 is securely held in place. Glazing bead 52 eliminates any gap between edges 46, 46A and window 40. Furthermore, any rattling or separation between edges 46, 46A and window 40 is eliminated since glazing bead 52 elastically re-forms to fill any gap therebetween. Moreover, due to its resilient nature, glazing bead 52 may be removed if necessary, such as to permit the door to be repainted.

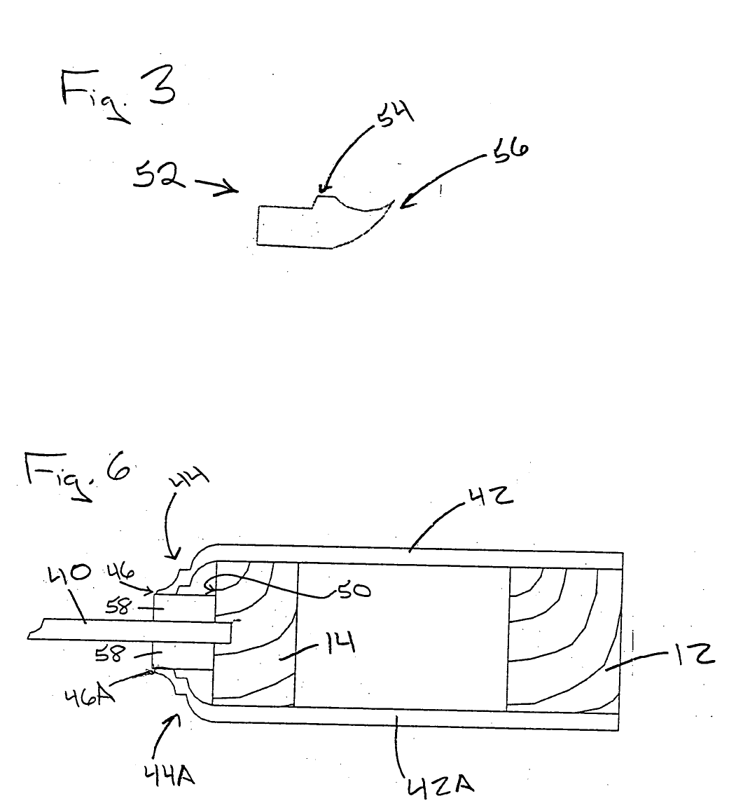

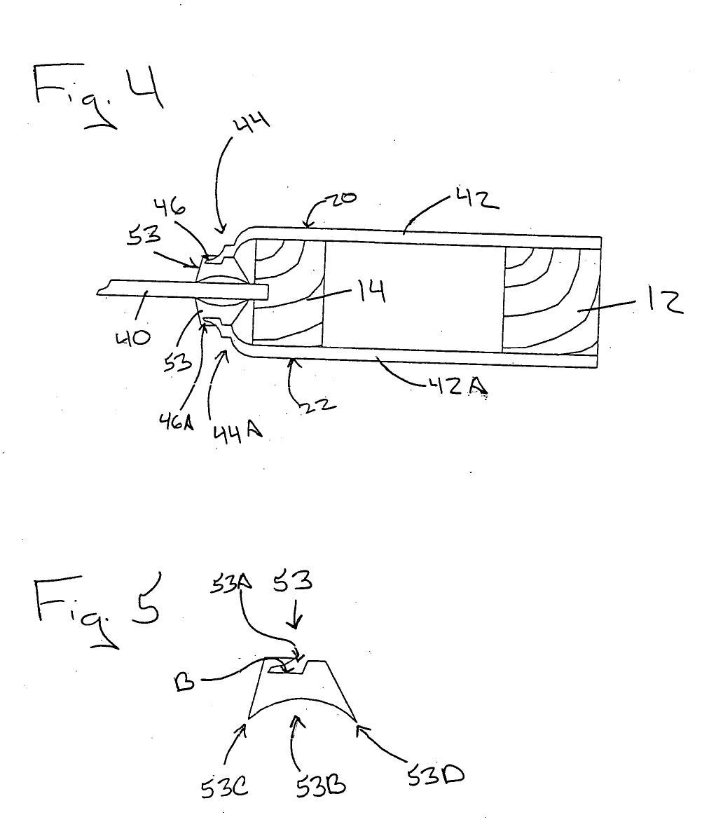

In a second embodiment, as best shown in FIGS. 4 and 5, a notched glazing bead 53 is disposed between contoured portion 44 and window 40, and between contoured portion 44A and the opposite side of window 40. Notched bead 53 may also be inserted into position after glazed door 10 is pressed. Similar to glazing bead 52, notched bead 53 is preferably formed from a resilient material, such as rubber, PVC, or a similar resilient material.

Notched bead 53 includes a notch 53A for receiving edges 46, 46A. Preferably notch 53A overlaps a portion of exterior surfaces 20, 22 adjacent edges 46, 46A. For example, notch 53A may have a depth of about 2.0 mm. In this way, any sharp or unfinished portions of edges 46, 46A are covered by notched bead 53. Notched bead 53 also includes a curved bottom 53B having outer and inner tips 53C, 53D. After door 10 is pressed, notched bead 53 is inserted into position, as best shown in FIG. 4. When inserted, outer and inner tips 53C, 53D are compressed and bend outwardly. Outer and inner tips 53C, 53D partially re-form after edges 46, 46A are received within notch 53A, but remain tensioned against window 40. For example, notched bead may have a thickness of about 8.0 mm prior to installation. If notch 53A is 2.0 mm, the thickness of notched bead 53 from a bottom B of notch 53A to outer and inner tips 53C, 53D may be about 6.0 mm. This 6.0 mm portion may be compressed to about 5.0 mm after glazed bead 53 is inserted in finished door 10. Thus, window 40 is securely held in place.

In a third embodiment, as best shown in FIG. 6, semi-rigid foam 58 is disposed between contoured portion 44 and window 40, and contoured portion 44A and the opposite side of window 40. Preferably, self-adhesive semi-rigid foam 58 is secured to window 40 before door 10 is pressed. Foam 58 may be any desired color. Foam 58 is preferably adhered to window 40 so that one side of foam 58 is flush with inwardly facing surface 50 on window frame 14. In addition, foam 58 has a sufficient thickness so that any gaps between edges 46, 46A and opposite sides of window 40 are filled by foam 58. Edges 46, 46A may also be adhesively secured to foam 58, either with an additional adhesive or by using a foam 58 having double-sided adhesive surfaces, as known in the art.

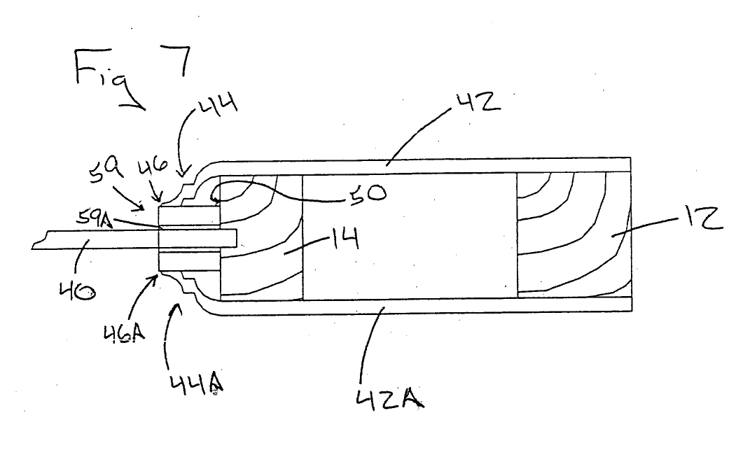

In a fourth embodiment, as best shown in FIG. 7, a solid spacer 59 is disposed between contoured portion 44 and window 40, and contoured portion 44A and the opposite side of window 40. Spacer 59 includes an adhesive layer 59A. Adhesive layer 59A may be double-sided foam tape, or some other resilient material that adheres to both spacer 59 and window 40. Solid spacer 59 may be plastic, PVC, wood, wood composite or some other suitable material. Spacer 59 may have a rectangular configuration, having a length of about 15 mm and a thickness of about 4.5 mm, for example. Spacer 59 preferably abuts surface 50 of window frame 14.

Adhesive layer 59A has a sufficient initial thickness so that it is partially compressed after installation between edges 46, 46A of contoured portions 44, 44A. For example, adhesive layer 59A may have an initial thickness of about 1.0 mm prior to installation, so that spacer 59 and adhesive layer 59A have a total thickness of about 5.5 mm. After door 10 is pressed, adhesive layer 59A is partially compressed to a thickness of about 0.5 mm, so that spacer 59 and adhesive layer 59A have a total thickness of about 5.0 mm in finished door 10. It should be understood that the thickness of spacer 59 and adhesive layer 59A may vary depending on the profile depth of contoured portions 44, 44A, as well as the thickness of window 40. Therefore, the thickness values disclosed herein are for purposes of explanation, and the invention is not so limited. Rather, spacer 59 and adhesive layer 59A may be any appropriate thickness so long as they may be secured between edges 46, 46A and opposing sides of window 40, and tension spacer 59 against edges 46, 46A. Spacer 59 and adhesive layer 59A are preferably secured to window 40 before door 10 is pressed. During pressing, adhesive layer 59A is compressed. After door 10 is pressed, adhesive layer 59A partially expands and forces spacer 59 against edges 46, 46A.

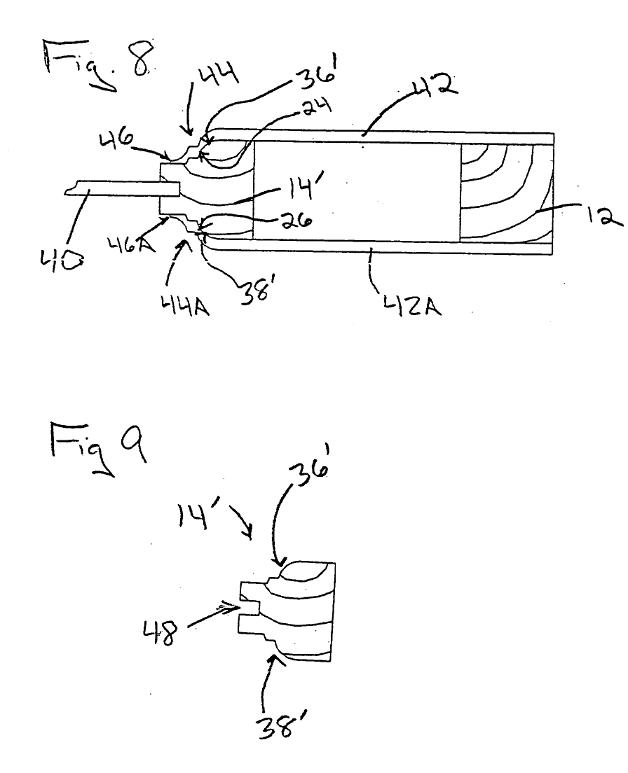

In a fifth embodiment, a window frame 14′ is provided having contoured first and second sides 36′, 38′, as best shown in FIGS. 8 and 9. First and second sides 36′, 38′ are preferably formed to have a configuration corresponding to interior surfaces 24, 26 of contoured portions 44, 44A, as best shown in FIG. 8. In this way, contoured portions 44, 44A may be secured flush against first and second sides 36′, 38′ of window frame 14′. Window frame 14′ also preferably include groove 48, as described above. Thus, glazing bead 52, notched bead 53, foam 58, solid spacer 59, or some other filler is not required.

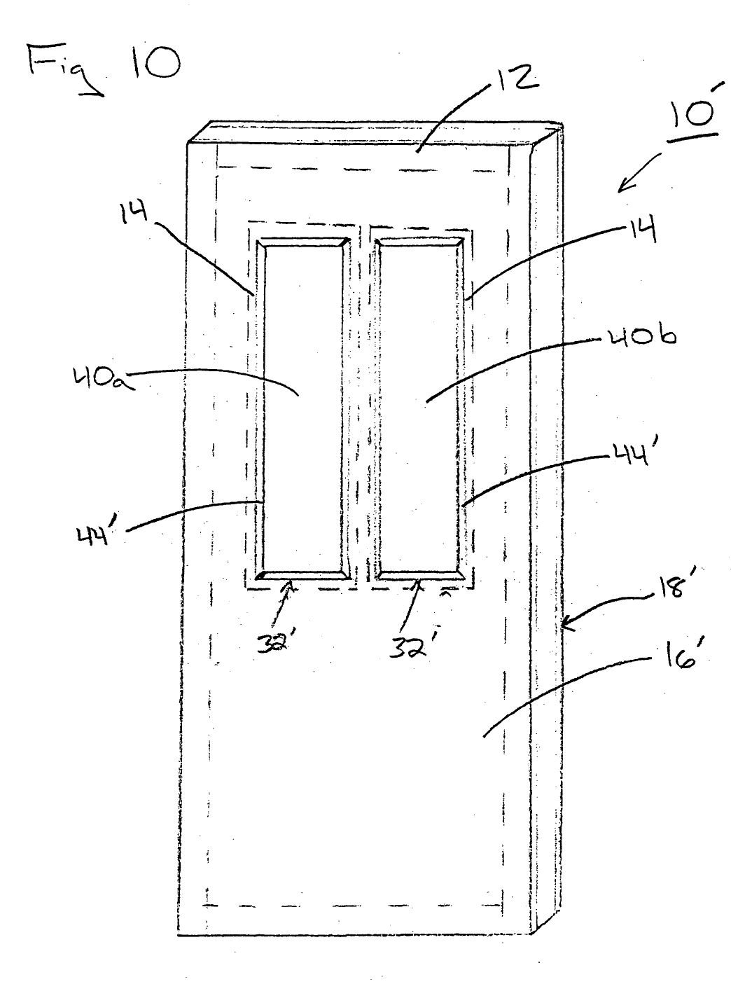

As best shown in FIG. 10, a glazed door 10′ according to the present invention may include two or more windows 40a, 40b. Glazed door 10′ includes similar components to door 10, but includes two openings 32′ on door facing 16′, and two openings 34′ on door facing 18′ (not shown). As such, door facing 16′ preferably includes contoured portions 44′ defining openings 32′. Windows 40a and 40b are secured within two window frames 14, as described above. Door 10′ may also include spacers, such as bead 52 or 53, foam 58, or spacer 59, as described above. It should be understood that any number of windows 40 may be provided in glazed door 10′ depending on consumer preference. Door facing 18′ is similarly configured to have openings aligned with openings 32′. Also, while the openings 32′ are shown as being rectangular, other shapes are possible as desired by consumers. The frames 14 are rectangular, in order to avoid the cost of special shapes for the windows 40a and 40b.

As best shown in FIG. 11, a glazed door 10″ according to the present invention includes two windows 40a, 40b as well as simulated panel portions P1 and P2. Panel portions P1, P2 are defined by contoured portions 60. It should be understood that door 10″ may include any number of simulated panels depending on consumer preference. Formation of such simulated panels in door facings 16, 18 is well known in the art, such as disclosed in U.S. Pat. No. 5,543,234 of Lynch et al., referenced above.

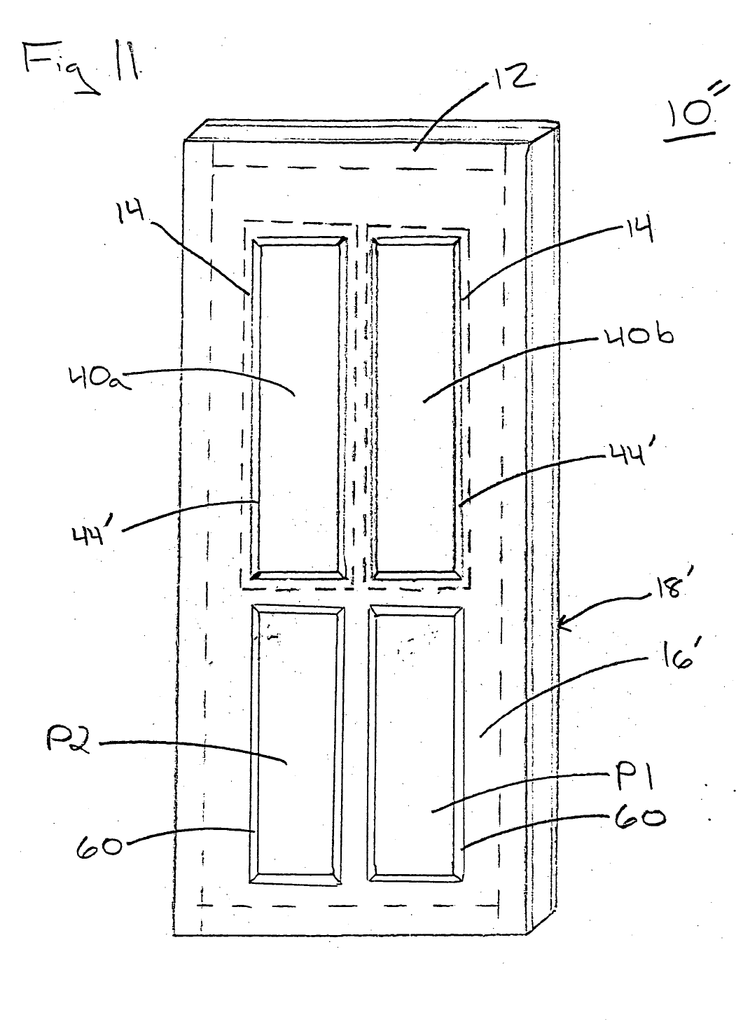

The present invention is also directed to a method of making a glazed door. First and second door facings 16, 18 are provided, as described above. For purposes of explanation, the present invention will be described with reference to door facing 16. However, it should be understood that door facing 18 is similarly configured. Door facing 16 includes a major planar surface 42 and at least one contoured portion 60 defining a panel P. Contoured portion 60 includes a base 62, as best shown in FIG. 12. As noted above, door facing 16 (and 18) may include any number of contoured portions 60 and panels P. Furthermore, contoured portion 60 may have one of various profiles. However, base 62 of contoured portion 60 is preferably inwardly recessed from the plane of major planar surface 42 relative to exterior surface 20.

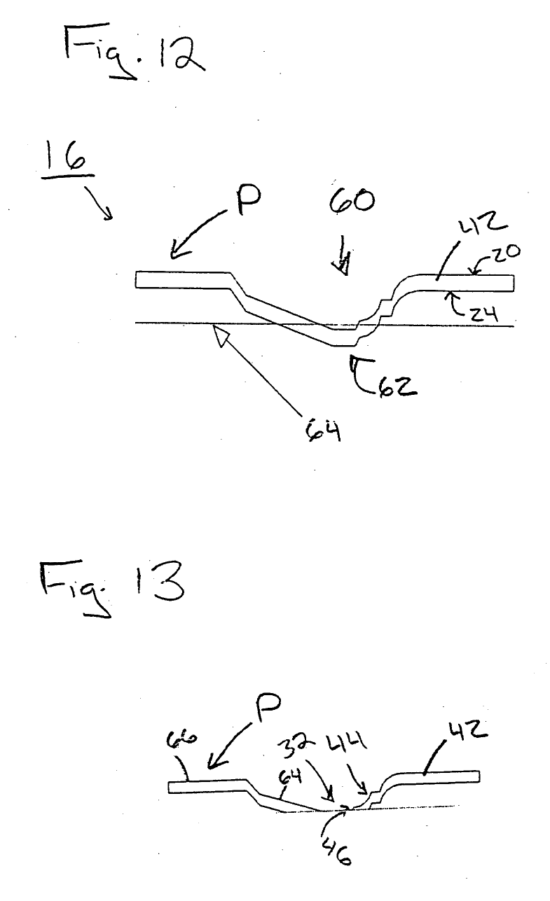

Panel portion(s) P is removed from door facing 16, preferably by sanding, such as through use of a belt sander, to form opening 32, which severs panel portion P from the remaining portions of door facing 16. Preferably, base 62 of interior surface 24 is sanded to sanding line 64. Thus, panel portion P is detached and removed from the remaining facing 16. Door facing 16 includes contoured portion 44 after sanding to sanding line 64, as best shown in FIG. 13. Panel portion P may also be removed from facings 16, 18 by routing out, cutting or planing through base 62. However, sanding is preferred because the sanding process results in a smooth, finished edge 46 along opening 32 (and 34). In addition, the sanding process is typically faster and more efficient than other methods of removing panel portion P.

Base 62 may also be formed to have a relatively thin caliper, or a variable caliper forming a “perforated” base 62. Specifically, the caliper of base 62 may have alternating portions of relatively standard caliper (i.e. 3.0 mm or less) with relatively thin caliper portions (i.e. 2.0 mm or less). An alternating high density/low-density fraction area is thereby formed by the alternating calipers. Panel P may be easily removed from facing 16 (or 18) along the perforated high density/low density fraction area. Specifically, sufficient areas of relatively thin caliper are provided so that panel P breaks along the perforation (i.e. the alternating high density/low density area) when a force is applied to panel P. Any sharp or uneven surfaces along edges 46, 46A may then be finished by sanding or rounding if desired. Alternatively, a spacer that curves around and covers edges 46, 46A may be used to cover any uneven surfaces, such as notched bead 53 as best shown in FIGS. 4 and 5. Additionally, in this embodiment, the door facings may be manufactured from wood composites, thermoplastics, polymers, and like materials.

The foregoing describes a mechanical operation to remove the panel P in order to form an opening in which a window frame and window may be received. It should be understood that in the manufacture of a door skin, two dies are brought together to create the molded substrate forming the door skin. We envision that the opposed dies may have elements that are brought into contact or by-pass, so that the panel P is severed from the remaining portion of the substrate during the molding process. In that event, the panel P would be removed from the mold separately from the remaining surrounding portion of the door skin, such as through a blast of pressurized air, mechanical pick-up, and the like. Moreover, the door skin could be molded from wood composites, polymeric materials, and like compositions from which door skins are manufactured.

As best shown in FIG. 21, upper die 300 and lower die 302 are positioned within a press for forming a door skin 304 and a panel 306. Upper die 300 preferably has a knife-edge 308 that extends continuously and uninterruptedly about the ovalo 310 of the molded door skin. The knife-edge 308 engages the opposed surface of lower die 302 when the dies are in the closed position, so that the material being molded, wood composite or polymer, is severed and thereby panel 306 and door skin 304 formed. The knife-edge thus allows panel 306 to be separated from the surrounding material, so that it may be removed when the press (not shown) opens the dies 300 and 302. While we show the knife edge 308 as extending from the upper die 300, those skilled in the art recognize that there could be a knife edge extending from each of the dies for engagement or that the knife edges may pass close by each other much like scissors in order to sever the material.

After removing panels P, door facings 16, 18 include openings 32, 34. Of course, additional openings may be sanded or routed if more than one window 40 is desired (such as with door 10′ or 10″). Peripheral frame 12 and window frame 14 are provided, as known in the art. Window 40 is secured within window frame 14, preferably within groove 48. Self-adhesive, semi-rigid foam 58 or spacer 59 may be secured to window 40 either before or after window 40 is secured within window frame 14. However, window 40 is preferably pre-assembled within window frame 14 prior to pressing. The components are then positioned in a press, with peripheral doorframe 12 and window frame 14 sandwiched between interior surfaces 24, 26 of facings 16, 18. Window frame 14 is aligned with, and adjacent to, openings 32, 34 and edges 46, 46A. Facings 16, 18 are preferably secured to peripheral doorframe 12 and window frame 14 using conventional adhesive, such as polyvinyl acetate. The components are then pressed together to form a door.

If glazed bead 52 or notched bead 53 is used, it may be installed around window 40 as described above after door 10 is pressed. Alternatively, the perimeter of opposing sides of window 40 (or the entire window 40) may be covered while door 10 is painted. With window 40 completely covered, such as with cardboard or paper, door 10 may be easily and efficiently painted or a finish coat applied. After painting, window 40 is again exposed, and glazing bead 52 or notched bead 53 installed. This method allows for efficiently finishing door 10, such as by applying a finish coat to exterior surfaces 20, 22. Crisp paint delineation may be achieved between exterior surfaces 20, 22 and window 40, and no paint or finish is splattered on glazing bead 52 or notched bead 53 since it is not installed until after application of the finish coat.

If a spacer and/or filler is not used, such as in the fifth embodiment, the associated interior surfaces 24, 26 of contoured portions 44, 44A are secured flush against first and second sides 36′, 38′ of window frame 14′ during pressing. It should be understood that first and second sides 36′, 38′ may have various configurations, depending on the profile of contoured portions 44, 44A and consumer preference. Alternatively, other spacers may be used instead of glazing bead 52 or foam 58, such as rubber spacers.

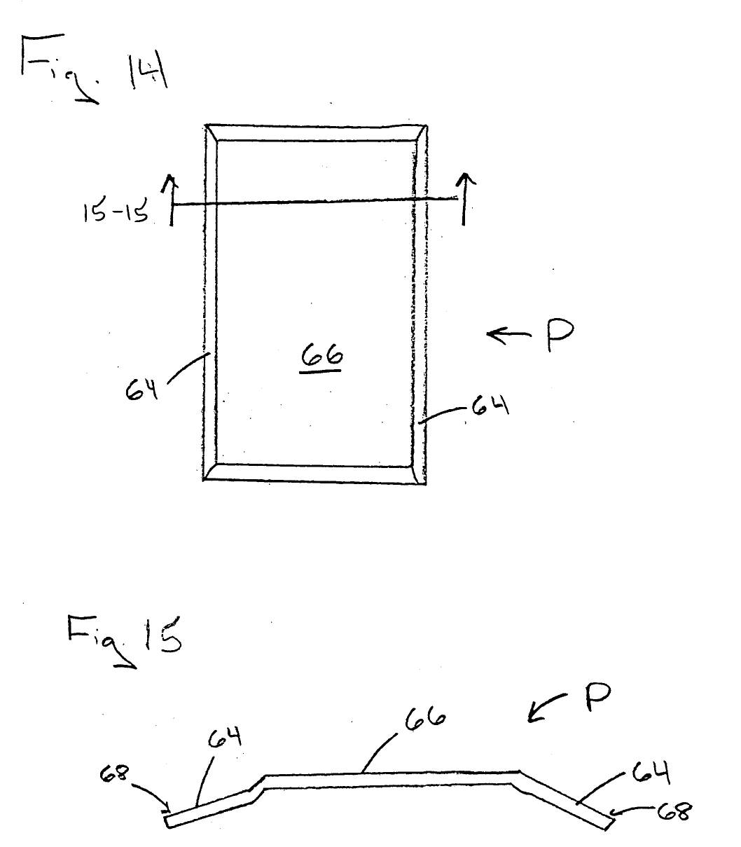

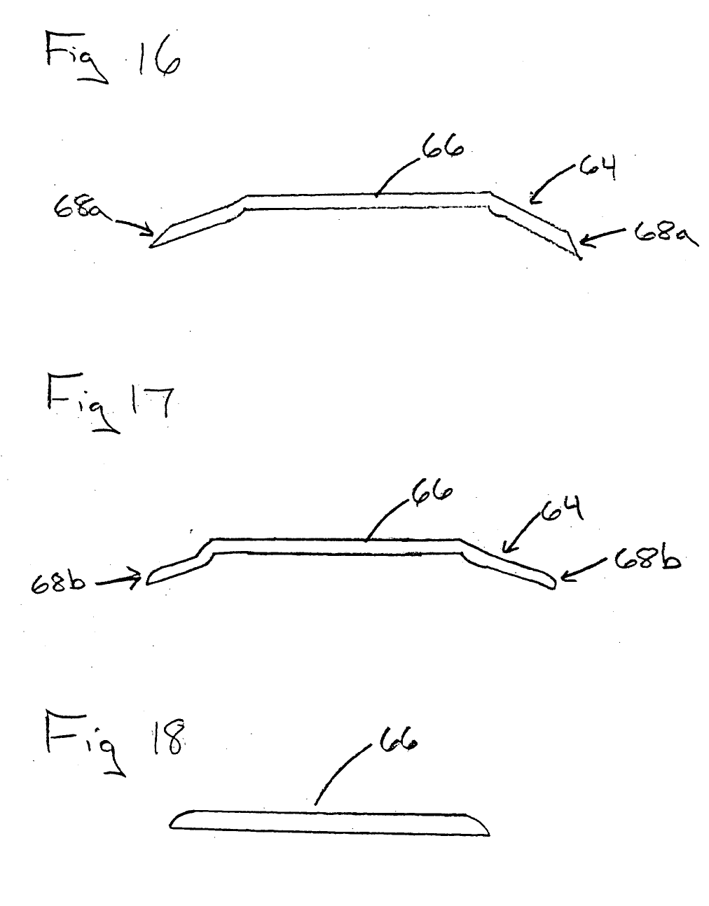

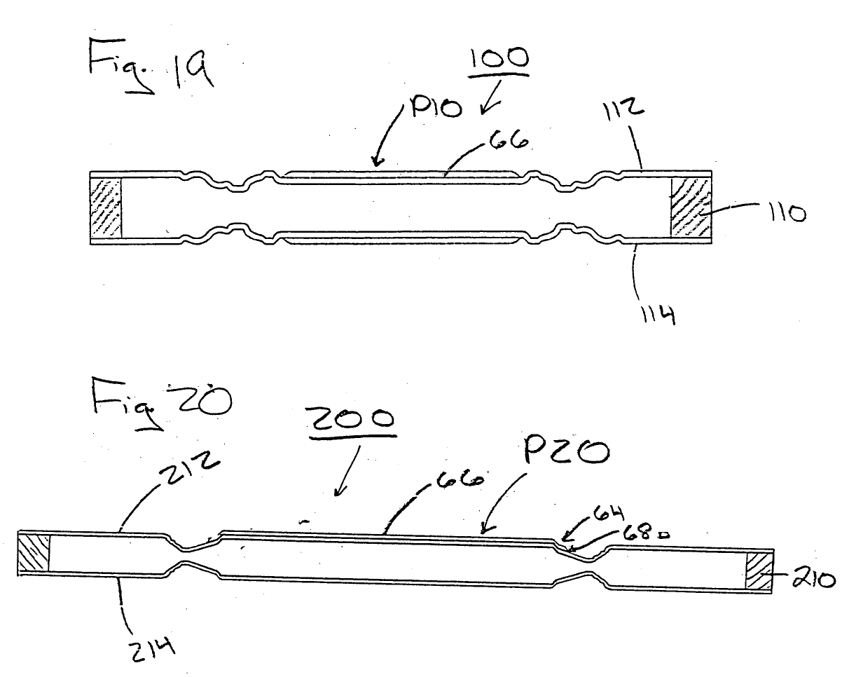

In a preferred embodiment of the present invention, the resulting panel P removed from facing 16 (or 18) is then used as a plant-on component. As best shown in FIGS. 14 and 15, panel P includes a skirt portion 64 and a planar portion 66. Skirt portion 64 is angled downwardly relative to planar portion 66. Skirt portion 64 is formed when sanding or routing out base 60 of contoured portion 44 (as shown in FIG. 13).

An outer end 68 of skirt portion 64 may be cut or sanded to have an angled edge 68a, as best shown in FIG. 16. Alternatively, outer end 68 may be sanded to have a curved edge 68b, as best shown in FIG. 17. Skirt portion 64 may also be completely removed, leaving only planar portion 66, as best shown in FIG. 18.

Panel P may then be adhesively secured to a surface as a decorative plant-on component. As known in the art, plant-on components provide a cost efficient alternative to complete replacement of a door or other surface (such as wainscot, cabinet doors, furniture doors, and the like) for changing the contour and appearance of the surface. For example, plant-on panel component P10 may be secured to opposing sides of a door 100, as best shown in FIG. 19. Panel component P10 includes only planar portion 66. Door 100 includes a peripheral frame 110 and first and second door facings 112, 114. Each facing 112, 114 has an interiorly disposed surface, which are secured to opposing sides of frame 110. Use of plant-on component P10 thus provides an appearance to door 100 that is aesthetically attractive to consumers. Moreover, through use of plant-on component P10, a different appearance is achieved for the resulting door while avoiding the need for a different die set to create that appearance. The cost of the die set and the expense of its installation preclude manufacture of small numbers of door facings. The plant-on component P10, by using what heretofore was scrap material, allows the manufacture of limited numbers of doors at relatively little additional cost.

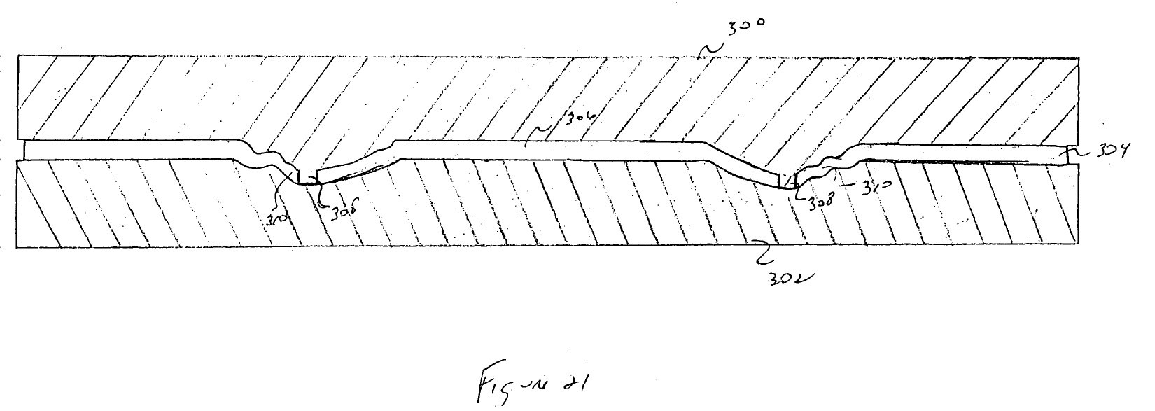

As best shown in FIG. 20, plant-on panel component P20 is secured to door 200. Panel component P20 includes panel portion 66 and skirt portion 64 with finished curved edges 68b. Door 200 includes a peripheral frame 210 and first and second door facings 212, 214. Each facing 212, 214 has an interiorly disposed surface, which are secured to opposing sides of frame 210. Panel component P20 is configured to be secured to a door facing 212 having a contoured portion molded therein.

Alternatively, skirt portion 64 may be tensioned against a planar surface. When viewed in cross-section, skirt portion 64 is disposed angularly relative to the plane of panel portion 66 (as shown in FIGS. 12-14). Preferably, skirt portion 64 is angled inwardly at least 5° from the plane of panel portion 66. When skirt portion 64 is forced against and secured to a planar surface, skirt portion 64 is deformed to be substantially coplanar with panel portion 66. This creates a tensioning force between skirt portion 64 and the planar surface to which the plant-on panel component is being secured. This tensioning force is not, however, sufficient to pull the panel component free from the surface. Rather, the tensioning force eliminates the formation of any potential gaps between outer end 68 and the surface, as described more fully in co-pending patent application titled “Reverse Molded Plant-On Panel Component, Method Of Manufacture, And Method Of Decorating A Door Therewith”, Ser. No. 10/400,443, for Lynch et al., filed Mar. 28, 2003, the disclosure of which is incorporated herein by reference.

Certain aspects of the present invention have been explained according to preferred embodiments. However, it will be apparent to one of ordinary skill in the art that various modifications and variations can be made in construction or configuration of the present invention without departing from the scope or spirit of the invention. Thus, it is intended that the present invention cover all such medications and variations.

1. A door, comprising:
a peripheral door frame;
a window frame having opposed first and second sides;
first and second door facings secured to said peripheral door frame and each of said door facings having an opening, each door facing having an inner surfaces and each of said window frame sides secured to an associated inner surface about the associated opening; and
a window secured within said window frame.

2. The door of claim 1, wherein said window frame has a thickness that is substantially equal to a thickness of said peripheral doorframe.

3. The door of claim 2, wherein the thickness of said window frame is between about 28 mm and about 38 mm.

4. The door of claim 1, wherein said window frame has a groove for receiving said window.

5. The door of claim 1, wherein each of said door facings has a contoured portion defining the opening.

6. The door of claim 5, wherein said contoured portions are secured to said opposing first and second sides of said window frame.

7. The door of claim 1, wherein spacers secure opposing first and second sides of said window within the door.

8. The door of claim 7, wherein each of said door facings has a contoured portion defining the opening.

9. The door of claim 8, wherein said contoured portions are secured to said spacers on each of said sides of said window.

10. The door of claim 9, wherein said spacers include self adhesive, semi-rigid component.

11. The door of claim 9, wherein each of said spacers comprises a curved tip connected to and operably associated with said window frame for tensioning said spacer against said window.

12. A method of making a door, comprising the steps of:
providing first and second door facings, each of the door facings having an inner surface and a panel portion;
removing the panel portion from each of the facings to form an opening;
providing a peripheral door frame;
providing a window frame having opposing first and second sides;
securing a window within the window frame;
securing the door facings to opposing sides of the peripheral door frame; and
securing an associated inner surface about the associated opening of each of the door facings to each of the window frame sides.

13. The method of claim 12, including the step of providing as the first and second door facings door facings having a contoured portion defining the panel portion.

14. The method of claim 13, including the step of removing the panel portion from each door facing by sanding off a base of the contoured portion.

15. The method of claim 12, including the step of securing an inner surface of each of the contoured portions on each of the door facings to the window frame.

16. The method of claim 12, including the step of securing a spacer to opposing first and second sides of the window.

17. The method of claim 13, comprising the further step of securing the removed panel portion to a surface.

18. The method of claim 17, including the further steps of:
removing the panel portion so that the panel portion includes a peripheral contoured portion; and
tensioning the peripheral contoured portion to a surface during said step of securing the removed panel portion.

19. The method of claim 18, including the further step of finishing the peripheral contoured portion to have a curved end.

20. The method of claim 12, including the step securing the window within a groove in the window frame.

21. A door, comprising:
a peripheral frame;
first and second door skins, each of said door skins secured to a side of said frame and at least one of said door skins has at least a first contoured panel portion; and
a wood composite panel overlying and secured to said first contoured panel portion.

22. A method of manufacturing a door, comprising the steps of:
providing a first door skin having at least a first contoured panel portion;
removing the panel portion;
preparing a door blank by securing second and third door skins to opposed sides of a door frame, at least one of the second and third door skins has a contoured panel portion; and
overlying and securing the removed panel portion to the at least one contoured panel portion.

23. A door skin, comprising:
a molded substrate having at least a first contoured panel portion, the substrate having first and second calipers and the calipers alternatingly disposed about said panel portion in order to provide a fraction area permitting said panel portion to be removed from said substrate.

24. The method of molding a door skin, comprising the steps of:
providing a mold die set having opposed contact elements arranged in a predetermined orientation to define a door skin and a panel;
placing a material to be molded within the opening of the mold die set;
closing the mold die set and causing the opposed contact elements to sever the material and thereby form the panel, having a configuration defined by the contact elements and removed from the surrounding portion of the material, and a door skin; and
opening the mold die set and removing the door skin and the panel.
